(19) United States
(12) Patent Application Publication
(10) Pub. No.: US 2024/0004986 A1
(43) Pub. Date: Jan. 4, 2024

(54) CLA CERTIFICATELESS AUTHENTICATION OF EXECUTABLE PROGRAMS

(71) Applicant: Cummins Inc., Columbus, IN (US)

(72) Inventors: Bhalchandra Phad, Pune (IN); Ashwani Mattoo, Jammu J&K (IN); Harshad Chandak, Pune (US); Christopher S. York, Greenwood, IN (US); Randall L. Wolf, Indianapolis, IN (US)

(21) Appl. No.: 18/340,064

(22) Filed: Jun. 23, 2023

(30) Foreign Application Priority Data
Jun. 30, 2022 (IN) 202241037818

(51) Int. Cl. G06F 21/44; H04L 9/32

(52) U.S. Cl. CPC G06F 21/44; H04L 9/3236

(57) ABSTRACT

A process provides certificateless securely authentication of an executable program. The process includes launching an executable program, the executable program including a secure program component, in response to a post-launch authentication trigger, calculating using the secure component a cryptographic hash function (CHF) digest of at least a portion of the executable program, accessing using the secure component a previously-calculated CHF digest of said at least the portion of the executable program contained in a white-box data structure of the executable program, comparing using the secure component the CHF digest and the previously-calculated CHF digest, and in response to the comparing indicating equality of the CHF digest and the previously-calculated CHF digest, authorizing an operation of the executable program.

### CROSS-REFERENCE TO RELATED APPLICATION

The present application claims priority to U.S. Provisional Application No. 63/367,378 filed on Jun. 30, 2022, of which is incorporated herein by reference in its entirety and for all purposes.

### TECHNICAL FIELD

The present application relates generally to cryptography and computer security and more particularly but not exclusively to certificateless authentication of executable programs.

### BACKGROUND

There is a significant and increasing need for authentication of executable programs in a variety of computing contexts. A number of proposals have been made for such authentication; however, the state of the art suffers from multiple disadvantages, shortcomings, and unsolved problems. Some proposals rely on certificate-based authentication in which a digital certificate is used to authenticate a device, program, or code. Digital certificates, also referred to as public key certificates, are electronic documents containing information about a public key of a public/private key pair, information about the identity of the certificate owner, and a digital signature (generated using the private key of the public/private key pair and a signing algorithm) of a certificate issuer, who may be the certificate owner or a separate certificate authority.

A number of certificate-based approaches have been proposed. While useful, certificate-based approaches pose a number of problems. For example, a certificate owner may be required to share or relinquish control over its certificates and their use for authentication to a third-party certificate authority. While the owner could retain sole control over its certificates and their use, the third-party certificate authority would then be denied their benefit. Another problem is that a certificate authority can be compromised, allowing issuance of malicious certificates that appear to be valid, but can be used to falsify authenticity of software that has been modified to include malware. Expiration and version tracking of digital certificates also presents administrative burdens and potential security problems. There remains a substantial, unmet, and widespread need for the unique devices, processes, and systems provided by the present disclosure.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as will occur to one skilled in the art with the benefit and insight of the present disclosure.

### SUMMARY OF THE DISCLOSURE

Example embodiments include unique apparatuses, methods, and systems for calibrating an electronic control unit. Further embodiments, forms, objects, features, advantages, aspects, and benefits shall become apparent from the following description and drawings.

### BRIEF DESCRIPTION OF THE FIGURES

FIG. 1 is a flow diagram illustrating certain aspects of an example process for performing certificateless secure authentication of executable programs.

FIG. 2 is a schematic diagram illustrating certain aspects of an example system for performing certificateless secure authentication of executable programs.

FIG. 3 is a flow diagram illustrating certain aspects of an example process for creating an executable program permitting certificateless secure authentication of executable programs.

FIG. 4 is a schematic diagram illustrating certain aspects of an example system for creating an executable program permitting certificateless secure authentication of executable programs.

### DETAILED DESCRIPTION OF EXAMPLE EMBODIMENTS

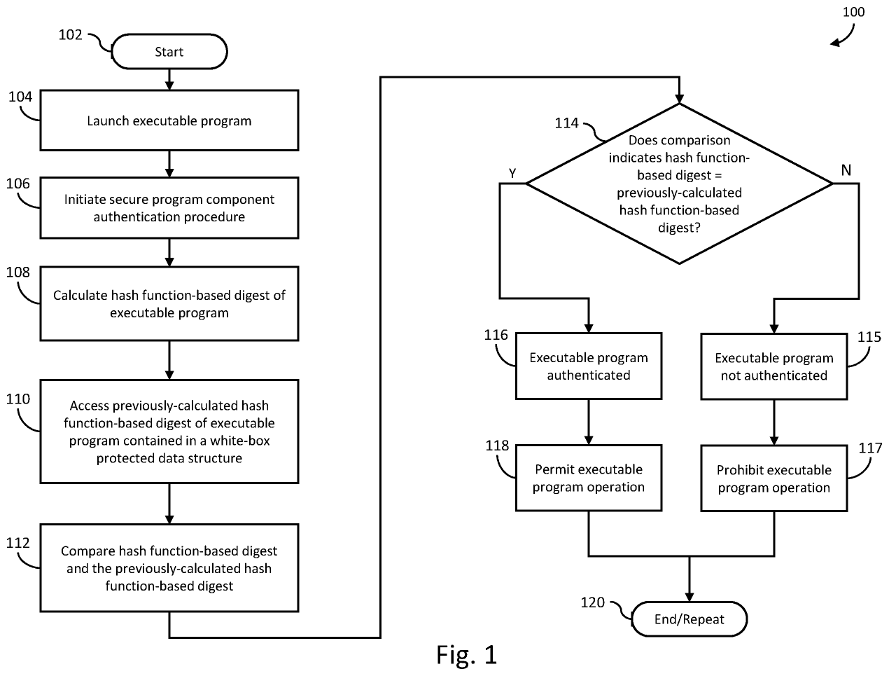

With reference to FIG. 1, there is illustrated a flow diagram illustrating certain aspects of an example process 100 for performing certificateless authentication of executable programs. It shall be appreciated that certificateless authentication refers to computer-based cryptographic authentication that can be successfully performed without use of a digital certificate. Furthermore, a certificateless authenticable package (CLA package) refers to and includes software packages consisting of, consisting essentially of, or comprising an executable program whose characteristics or associations with other package components allow it to be authenticated using certificateless authentication. Certificateless authentication and CLA packages may also be performed or used in combination with certificate-based authentication provided that at least one instantiation of authentication of such a combination does not require a digital certificate or use thereof.

It shall be appreciated that the terms utilized in describing certificateless authentication and CLA packages have technical meaning to persons of skill in the art. For example, a digital certificate or certificate refers to a file, object, or unit of code that contains the public key of a public/private key pair as well as data identifying the certificate owner who holds the corresponding private key and, therefore, can be used to authenticate an object (e.g., a file, message, or other object) whose cryptographic hash function (CHF) digest has been encrypted using the private key by comparing a digest produced by calculating a cryptographic hash of the object with a digest produced by decrypting the encrypted CHF digest of the object.

An executable program refers generally to a program provided as or in one or more files, objects, or other units of code that can be launched and executed by a computer including, for example, an app, application, script, or other executable for a desktop computer, embedded computer or controller, laptop computer, mobile device, smartphone, tablet, or other types of computers and computing devices. An executable program package refers to a set of software including at least one executable program and potentially including associated software components, for example, archives and components thereof, compression/decompression components, folders and components thereof, library components, installer components, linking components, resources, services, and other software components as will occur to one of skill in the art with the benefit and insight of the present disclosure.

Process 100 may be initiated by start operation 102, for example, by a user selecting or commanding launch of an executable program, or by another software component selecting or commanding such launch. The executable program may comprise any of a number of types of executable programs including, for example, applications or apps for mobile devices, laptops, desktops, servers, or other types of computers, as well as other types of executable programs as will occur to one of skill in the art with the benefit and insight of the present disclosure.

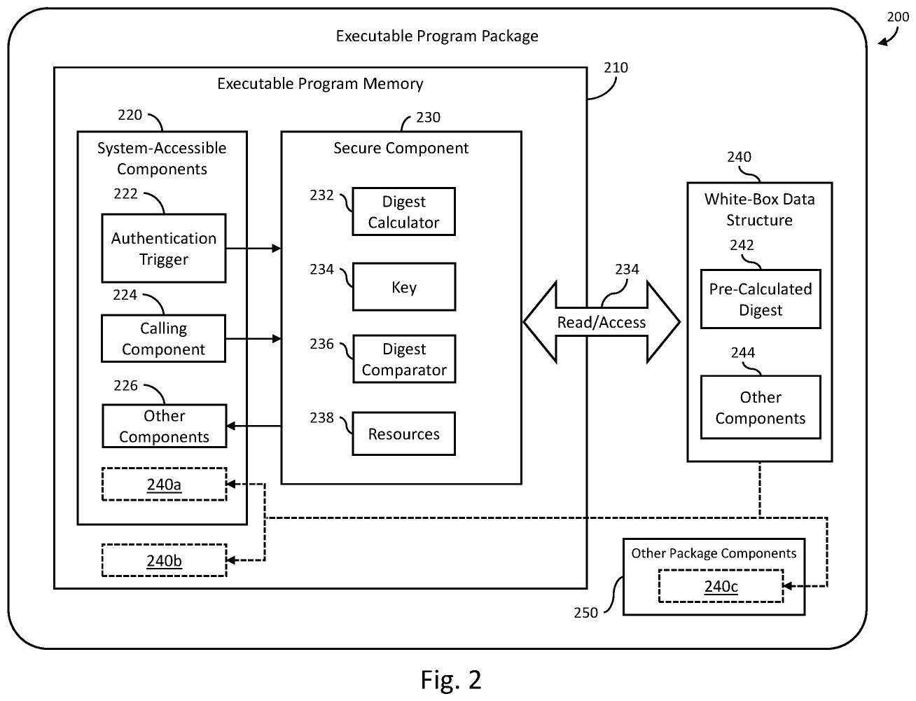

From operation 102, process 100 proceeds to operation 104 which launches an executable program. The executable program preferably includes a secure program component. In some forms, the secure program component may be, or may have some or all of the attributes, characteristics, and/or structure of secure component 230 which is illustrated and described in connection with FIG. 2 or the other secure components disclosed herein. In some forms, the secure program component may be, or may have some or all of the attributes, characteristics, and/or structure of other secure program components as will occur to one of skill in the art with the benefit and insight of the present disclosure.

From operation 104, process 100 proceeds to operation 106 which initiates or triggers an authentication procedure using the secure program component. Operation 106 may operate in a number of manners according to a number of forms. In some forms, operation 106 may immediately initiate or trigger the authentication procedure as the first operation of an executable program when launched. In some forms, operation 106 may immediately and exclusively initiate or trigger the authentication procedure as the first operation of an executable program when launched such that no other procedure or process of the executable program may be initiated with the authentication procedure. In some forms, operation 106 may immediately and exclusively initiate or trigger the authentication procedure as the first operation of an executable program when launched such that no other procedure or process of the executable program may be performed until completion of the authentication procedure. In some forms, operation 106 may initiate or trigger the authentication procedure after the executable program is launched and some other launch procedures or other program procedures have been initiated and/or completed such that operation 106 is not immediately or not exclusively the first operation of an executable program when launched. In some forms, operation 106 may initiate or trigger the authentication procedure after the executable program is launched and a calling component of the executable program attempts to access or requests access to a restricted or secure resource. It shall be appreciated that the foregoing are examples of operation 106 being performed in response to the launching of an executable program. It shall likewise be appreciated that performance of operations subsequent to operation 106 may also be considered to be performed in response to the launching of an executable program. It shall be further appreciated that in the foregoing and other examples, operation 106 may functions or operates as a post-launch authentication trigger or authentication initiator.

From operation 106, process 100 proceeds to operation 108 at which the secure program component calculates a cryptographic hash function digest of the executable program. It shall be appreciated that the term digest refers to data output in response to input provided to a cryptographic hash function (CHF) which that maps an input of arbitrary size to an output of fixed size (i.e., the digest, sometimes also referred to as the hash or hash value) in a deterministic manner. Preferably, a CHF also has certain infeasibility characteristics, meaning that it is not practicable or is prohibitive in terms of computational time and power (even if theoretically possible) to perform certain operations relative to a CHF. For example, it is preferably infeasible to generate a message with a CHF that yields a given hash value (i.e. to reverse the process that generated the given hash value). It is also preferably infeasible to find two different inputs that produce the same digest when processed with a CHF. It is also preferable that a small change to input to a CHF will change the resulting digest so extensively that a new digest appears uncorrelated with the prior digest.

From operation 108, process 100 proceeds to operation 110 at which the secure program component accesses a previously-calculated hash function digest of the executable program contained in a white-box data structure. It shall be appreciated that a white-box data structure refers to and includes a number of data structures (e.g., data stores) protected using white-box cryptography (WBC) techniques and may also, therefore, be referred to as a white-box-protected data structure. In general, WBC techniques combine encryption and obfuscation to securely embed or associate protected objects (e.g. a digest, secret key, or other object) in the code of an executable program or program package. WBC techniques combine code and protected objects in such a way that an attacker cannot distinguish between the two and the WBC-protected executable program or program package can be safely executed in an insecure environment. An executable program or package may be referred to as white-box-protected when it includes one or more objects protected according to a WBC technique.

An example WBC implementation may embed both a protected object and random data in a composition from which it is hard to derive the original protected object, for example, by hard-coding a protected object into a series of key-dependent lookup tables which are protected by a randomization technique. Certain such implementation may utilize substitution-permutation network (SPN) block ciphers which (a) reorganize a cipher such substitution-box operations are adjacent to operations that includes the protected object, (b) hard code the secret key into the substitution-box, (c) inject annihilating affine transformation operations into an affine block cipher layer, (d) decompose all the affine operations into a series of lookup tables, and (e) inject random annihilating encodings into the sequence of lookup tables. It shall be appreciated that a variety of other WBC techniques are also contemplated.

From operation 110, process 100 proceeds to operation 112 at which the secure program component compares the hash function digest and the previously-calculated hash function digest to evaluate the equality of the hash function digest and the previously-calculated hash function. The comparison may include a number of operations. In some forms, the comparison may utilize an equal to or equality operator to compare the hash function digest from the previously-calculated hash function digest. In some forms, the comparison may subtract the hash function digest from the previously-calculated hash function digest (or vice versa) and compare the remainder to zero (0). In some forms, the comparison may perform other types of operations including, for example, dividing the hash function digest by the previously-calculated hash function digest (or vice versa) and comparing the quotient to one (1), or by performing other mathematical comparison operations effective to permit evaluation of the equality or identity of the hash function digest from the previously-calculated hash function digest as will occur to one of skill in the art with the benefit and insight of the present disclosure.

From operation 112, process 100 proceeds to conditional 114 which evaluates whether comparison of operation 112 indicates that the hash function digest is equal or identical to the previously-calculated hash function digest. In some forms, the functionality of operation 112 and conditional 114 operational may be combined or performed by a single operator or conditional.

If conditional 114 evaluates affirmative, process 100 proceeds to operation 116 which sets the status of the executable program as authenticated. From operation 116, process 100 proceeds to operation 118 which, in response to the authenticated status of the executable program, authorizes one or more executable program operations. From operation 118, process 100 proceeds to operation 120 where process 100 may end or repeat.

If conditional 114 evaluates negative, process 100 proceeds to operation 115 which sets the status of the executable program as not authenticated. From operation 115, process 100 proceeds to operation 117 which, in response to the not authenticated status of the executable program, prohibits one or more executable program operations. From operation 118, process 100 proceeds to operation 120 where process 100 may end or repeat.

A number of types of executable program operations may be authorized in connection with operation 118 or prohibited in connection with operation 117. In some forms, the one or more executable program operations may comprise operation (or continued operation) of the executable program itself which may either be permitted (allowing the executable program to continue operating normally) or prohibited (resulting in the executable program being suspended or terminated). In some forms, the one or more executable program operations may comprise the executable program accessing one or more software components, for example, one or more software archive, library, or package components, or combinations thereof, as well as other types of software components. In some forms, the one or more executable program operations may comprise other executable program operations as will occur to one skilled in the art with the benefit and insight of the present disclosure

With reference to FIG. 2, there is illustrated a schematic diagram depicting certain aspects of an example executable program package 200 (also referred to herein as package 200) which is configured for and capable of certificateless authentication and, therefore, provides one example of a CLA package according to the present disclosure. Package 200 includes executable program memory 210 which, in turn, includes system-accessible or system-executable components 220 (also referred to herein as components 220), secure program component 230 (also referred to herein as component 230), and white-box data structure 240. As indicated by dashed boxes 240a, 240b, and 240c, white-box data structure 240 may have any of a number of relationships to the illustrated components of package 200 as further described herein. It shall be appreciated that such relationships are examples of a white-box data structure of an executable program and may also be considered a white-box data structure of a program package according to the present disclosure.

Components 220 may include core components of an executable program which may be directly accessed, called, read, and/or viewed by a user or a system on which package 200 is provided. In the illustrated embodiment, components 220 include an authentication trigger 222 and calling component 224, and may also include other components 226 as will occur to one of skill in the art with the benefit and insight of the present disclosure.

Authentication trigger 222 is configured to initiate an authentication procedure using the secure program components 230. Authentication trigger 222 may be configured to initiate an authentication procedure in a number of manners including, for example, in accordance with any of the example operations or techniques described above in connection with operation 106 as well as in other manners as will occur to one of skill in the art with the benefit and insight of the present disclosure.

Calling component 224 is configured to access or request access to one or more restricted or secure resources, such as restricted resources 238 of secure component 230. Access to such resources may be conditioned on the authentication procedure which is at least in part instantiated in and performed by secure component 230. If and when such access is granted, resources, such as restricted resources 238, may be utilized by calling component 224 and/or by other components 226.

Secure component 230 contains digest calculator 232, key 234, digest comparator 236, and restricted resources 238 and, in some forms may include other secure components Secure component 230 may be secured or protected using a number of techniques including, for example, storage in encrypted memory, which may be encrypted at a hardware layer, a firmware layer, a software layer, or combinations thereof, as well as other forms cryptographic key-based storage, password-protected storage, credential-protected storage, or other types of protected or secure storage as will occur to one of skill in the art with the benefit and insight of the present disclosure. Such security and protection attributes and features provide protection and security for the constituent components of secure component 230 including digest calculator 232, key 234, digest comparator 236, and restricted resources 238. It shall be appreciated that while the protection and/or security features and techniques applied to secure component 230 are not applied to components 220, components 220 may optionally be separately secured or protected in various manners.

Digest calculator 232 is configured to calculate a CHF digest of package 200 or a component or portion thereof corresponding to the same component, portion, or entirety of package 200 from which pre-calculated digest 242 of white-box data structure 240 was calculated and using the same CHF calculation used to calculate pre-calculated digest 242. In some embodiments, digest calculator 232 may be configured to account for the presence of digest information in a component, portion, or entirety of package 200 that would otherwise inhibit certificateless authentication.

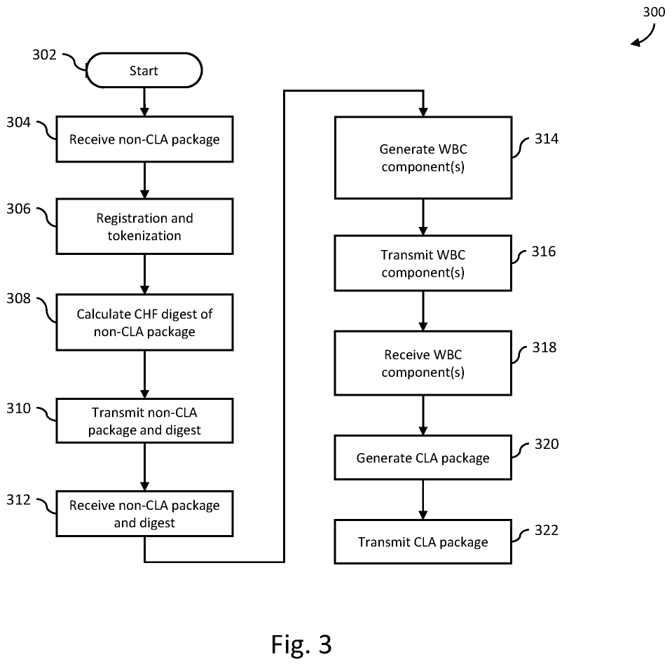

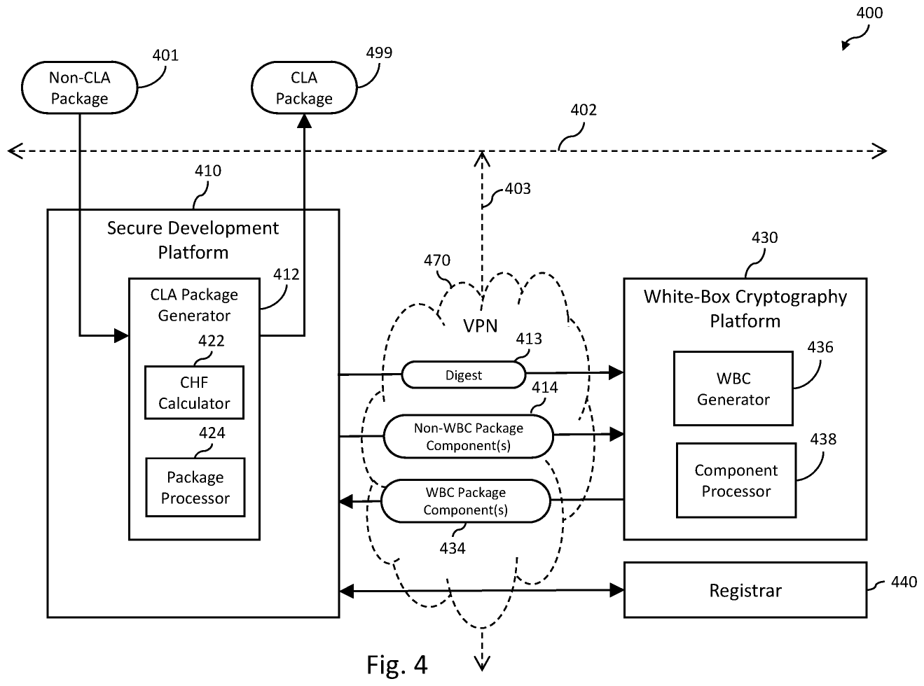

When package 200 is created or configured as a CLA package, for example, as described in connection with FIGS. 3 and 4, a CHF calculation is initially performed on package 200 or a or a portion thereof which does not include any data or information of white-box data structure 240. When created or configured to provide CLA, however, package 200 or a or a portion thereof includes the data and information of white-box data structure 240. Thus, a subsequent CHF calculation performed on CLA form of package 200 or a CLA form of a portion thereof, will produce a different digest than the digest initially calculated in the CLA creation or configuration process. Accordingly, digest calculator 232 may be configured to ignore or omit some portion of package 200 to avoid calculating a digest that would be unsuitable for authentication purposes. Thus, for example, if white-box data structure 240 is provided in a form as indicated dashed boxes 240b or 240c (as is further described herein below), digest calculator 232 may be configured to calculate a CHF digest of components 220. In other forms, where white-box data structure 240 is provided wholly or partially in a form as indicated by dashed box 240a (as is further described herein below), digest calculator 232 may be configured to calculate a CHF using only a portion of components 220 which are defined or known to be exclusive of white-box data structure 240.

Key 234 is a cryptographic key which is configured and useable by secure component 230 to access white-box data structure 240 by decrypting and un-obfuscated from the data with which it was combined, embedded, integrated, and/or otherwise cryptographically associated according to one or more WBC technique such as the WBC techniques described herein or other WBC techniques as will occur to one of skill in the art with the benefit and insight of the present disclosure.

Digest comparator 236, is configured and useable by secure component 230 to compare a CHF digest calculated by digest calculator 232 with pre-calculated digest 242 white-box data structure 240, for example, using techniques such as those described in connection with operation 112 or other comparison techniques as will occur to one of skill in the art with the benefit and insight of the present disclosure.

Resources 238 may include any of a number of types of restricted resources, for example, credentials, keys, libraries or library components (e.g., dynamic link libraries (DLL), other types of dynamic libraries, and static libraries), shared objects, or in principle, any code, file, or resource over which security or protection is desired.

White-box data structure 240 contains pre-calculated digest 242 and, optionally and in some forms, may also include other components 244. Pre-calculated digest 242 is a CHF digest calculated when package 200 is created or configured as a CLA package, for example, as described in connection with FIGS. 3 and 4. White-box data structure 240 is an example of a white-box-protected data structure which may be protected and secured according to WBC techniques such as those disclosed herein. WBC techniques may combine encryption and obfuscation to securely combine, embed, integrate, and/or otherwise cryptographically associate pre-calculated digest 242 in or with other code of package 200.

White-box data structure 240 may relate to the illustrated components of package 200 and may be combined, embedded, integrated, and/or otherwise cryptographically associated in or with such components in a number of manners as generally indicated by dashed boxes 240a, 240b, and 240c. For example, white-box data structure 240 may be combined, embedded, integrated, or otherwise cryptographically associated with: system components 220 or executable program memory 210 (as indicated by dashed box 240a), other components or locations of executable program memory 210 (as indicated by dashed box 240b), or other package components 250 which may reside in whole or in part outside of or separately from executable program memory 210 (as indicated by dashed box 240c). Additionally, white-box data structure 240 may be combined, embedded, integrated, or otherwise cryptographically associated with combinations of the foregoing examples, for example, with two or more the components and/or locations indicated by dashed boxes 240a, 240b, 240c, or with all of such components and/or locations. Furthermore, white-box data structure 240 may be combined, embedded, integrated, or otherwise cryptographically associated with one or more components and/or locations using a variety of techniques including any of the WBC techniques disclosed herein as well as other techniques as will occur to one of skill in the art with the benefit and insight of the present disclosure.

With reference to FIG. 3, there is illustrated a flow diagram depicting certain aspects of an example process 300 for creating an executable program permitting certificateless secure authentication of executable programs. Process 300 may be performed in connection with a number of networks and systems including, for example, system 400 described in connection with FIG. 4 as well as other networks and systems as will occur to one of skill in the art with the benefit and insight of the present disclosure.

Process 300 may be initiated by start operation 302, for example, by a developer providing a non-CLA form of a software package to a secure development platform (SDP), such as SDP 410 described below in connection with FIG. 4 or other suitable development computers, machines, systems, and/or other types of platforms as will occur to one of skill in the art with the benefit and insight of the present disclosure.

From operation 302, process 300 proceeds to operation 304 at which the non-CLA form of the software package is received at the SDP. From operation 304, process 300 may proceed to operation 306 which registers the software package with a registrar (e.g., a third-party certificate authority, publisher, or distributor of a CLA form of the software package). Upon such registration, a token or tokened claim may be generated by and received from the registrar and, once received, may be stored in an authentication library maintained on or by the SDP. It shall be appreciated that a variety of registration and tokenization techniques and operations may be utilized as will occur to one of skill in the art with the benefit and insight of the present disclosure.

From operation 306, process 300 proceeds to operation 308 which uses a CHF to calculate the digest of the non-CLA form of the software package. Operation 308 may utilize a variety of CHF components, operations, and techniques such as the examples disclosed herein or other examples as will occur to one of skill in the art with the benefit and insight of the present disclosure.

From operation 308, process 300 proceeds to operation 310 which transmits the digest and one or more components of or the entirety of the non-CLA form of the software package to a white-box cryptography platform. From operation 310, process 300 proceeds to operation 312 which the digest and the non-CLA form of the software package are received by the white-box cryptography platform. The digest and the one or more components of or the entirety of the non-CLA form of the software package may be transmitted and received together or separately and in a single message or multiple messages which may be further packetized and/or encrypted and which may be transmitted over a secure network such as a virtual private network (VPN).

From operation 312, process 300 proceeds to operation 314 which generates one or more WBC-protected software package components (also referred to as WBC package components). Operation 314 may generate the one or more WBC package components using WBC protection techniques such as those disclosed herein. The generation of one or more WBC-protected package components may include combining, embedding, integrating, and/or otherwise cryptographically associating the digest with the one or more components of or the entirety of the non-CLA form of the software package effective to generate the one or more WBC package components.

From operation 314, process 300 proceeds to operation 316 which transmits the one or more WBC package components to the SDP. From operation 316, process 300 proceeds to operation 318 at which the one or more WBC package components are received at the SDP. The one or more WBC package components may be transmitted and received together or separately and in a single message or multiple messages which may be further packetized and/or encrypted and which may be transmitted over a secure network such as a virtual private network (VPN).

From operation 318, process 300 proceeds to operation 320 which generates a CLA form of the software package including the one or more WBC package components. Operation 320 may use a number of techniques to generate the CLA form of the software package. In some forms, the one or more WBC package components may include all or substantially all of the components of the CLA form of the software package in which case, no substantial changes to the CLA form of the software package need to be made and operation 320 may be limited to storing, indexing, and/or registering the CLA form of the software package. In some forms, the one or more WBC package components may include only some of the components of the CLA form of the software package in which case, operation 320 may archive, combine, integrate, place in a common folder or directory, or otherwise associate or link the WBC package components with other software package components to create or provide the CLA form of the software package. From operation 320, process 300 proceeds to operation 322 which transmits or otherwise provides the CLA form of the software package to a destination external to the SDP.

With reference to FIG. 4, there is illustrated a schematic diagram depicting certain aspects of an example system 400 for creating an executable program permitting certificateless secure authentication of executable programs. System 400 may be configured to perform a number of processes to create or configure a CLA form of a software package (e.g., CLA package 499) from a non-CLA form of a software package (e.g., non-CLA package 401) including, for example, process 300 described in connection with FIG. 3 as well as other processes as will occur to one of skill in the art with the benefit and insight of the present disclosure. In the illustrated embodiment, system 400 is provided in the form of a network including multiple systems and components as further described below. In other forms, system 400 could be provided as a unitary system, for example as a data center, server, or other a unitary computing system.

System 400 includes a secure development platform (SDP) 410 and white-box cryptography (WBC) platform 430 which are preferably configured and provided as secure platforms which are separated from external networks and systems by one or more security features indicated generally by dashed arrow 402. In some forms, SDP 410 and WBC platform 430 may be further separated from one another by one or more security features indicated generally by dashed arrow 403. The security features indicated by dashed arrows 402 and 403 may include, for example, conditional access systems, DMZs, firewalls, gateways (inbound and/or outbound), honeypots, honeynets, packet filters, or other network security systems as will occur to one of skill in the art with the benefit and insight of the present disclosure.

SDP 410 includes CLA package generator 412 which is configured to receive an input including non-CLA package 401 and to provide an output including CLA package 499. CLA package generator 412. CLA package generator 412 includes cryptographic hash function (CHF) calculator 422 and package processor 424 and may, in some forms, include other components as will occur to one of skill in the art with the benefit and insight of the present disclosure.

CHF calculator 422 is configured to utilize a cryptographic hash function (CHF) to calculate a digest 413 of non-CLA package 401 or a component or portion thereof. CHF calculator 422 may perform such calculation using a number of CHF techniques such as those described herein or other techniques as will occur to one of skill in the art with the benefit and insight of the present disclosure.

Package processor 424 is configured to handle input/output and other communication aspects and operations between CLA package generator 412 and other systems or components including WBC platform 430 as well as systems and components of SPD 410. For example, package processor 424 may be configured to handle communications to register a software package with a registrar 440 (e.g., a third-party certificate authority, publisher, or distributor of a CLA form of the software package) and to receive and store or maintain a token or tokened claim generated by registrar 440 in an authentication library of the SDP. In some forms, package processor 424 may also be configured to perform various pre-WBC and post-WBC processing operations on or relating to software package components such as those described herein or other operations as will occur to one of skill in the art with the benefit and insight of the present disclosure.

Package processor 424 is further configured to facilitate or participate in the communication of digest 413 (which is calculated by CHF calculator 422) and non-WBC package components 414 (which includes one or more components of or the entirety of non-CLA package 401) from CLA package generator 412 and SDP 410 to WBC platform 430. In the illustrated embodiment, such communication includes a transmission over a virtual private network (VPN) 470. In some forms, such communication may include transmission over other types of secure networks. In some forms, such communication may include an intra-network transmission, for example, where SDP 410 and WBC platform 430 are provided on a common network or within a common computing system, such as a common data center (physical or virtual), or a set of one or more servers or other computers.

WBC platform 430 includes WBC generator 436, component processor 438, and may, in some forms, include other components as will occur to one of skill in the art with the benefit and insight of the present disclosure. WBC generator 436 is configured to generate WBC package components by combining embedding, integrating, or otherwise cryptographically associating digest 413 and non-WBC components 414. WBC generator 436 may generate WBC package components 434 according to one or more WBC techniques such as the WBC techniques described herein or other WBC techniques as will occur to one of skill in the art with the benefit and insight of the present disclosure.

Component processor 438 is configured to handle input/output and other communication aspects and operations between WBC platform 430 and other systems or components SPD 410 and components thereof. For example, component processor 438 is configured to facilitate or participate in the communication of WBC package components 434 from WBC platform 430 to CLA package generator 412 of SDP 410. In the illustrated embodiment, such communication includes a transmission over virtual private network (VPN) 470. In some forms, such communication may include transmission over other types of secure networks. In some forms, such communication may include an intra-network transmission, for example, where SDP 410 and WBC platform 430 are provided on a common network or within a common computing system, such as a common data center (physical or virtual), or a set of one or more servers or other computers.

Once CLA package generator 412 is further configured to generate CLA package 499 (which is a CLA form of non-CLA package 401) in response to WBC package components 434 received from WBC platform 430. A number of techniques may be utilized to generate the CLA package 499. In some forms, the WBC package components 434 may include all or substantially all of the components of the CLA package 499 in which case, no substantial changes or further processing is needed, although various operations such as storing, indexing, and/or registering the CLA package 499 may be performed. In some forms, WBC package components 434 may include only some of the components of the CLA package 499 in which case, WBC package components 434 may be archived, combined, integrated, placed in a common folder or directory, or otherwise associated or linked with other package components to create or provide CLA package 499.

While exemplary embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred, or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A process for certificateless securely authenticating an executable program, the process comprising:
launching an executable program, the executable program including a secure program component;
in response to a post-launch authentication trigger, calculating using the secure component a cryptographic hash function (CHF) digest of at least a portion of the executable program;
accessing using the secure component a previously-calculated CHF digest of said at least the portion of the executable program contained in a white-box data structure of the executable program;
comparing using the secure component the CHF digest and the previously-calculated CHF digest; and
in response to the comparing indicating equality of the CHF digest and the previously-calculated CHF digest, authorizing an operation of the executable program.

2. The process of claim 1, wherein the post-launch authentication trigger initiates an authentication procedure including the calculating as one of an immediate post-launch operation, and an immediate and exclusive post-launch operation.

3. The process of claim 1, wherein the calculating includes calculating the CHF digest of the entirety of the executable program.

4. The process of claim 1, wherein the accessing includes using a key to access the previously-calculated CHF digest contained in the white-box data structure.

5. The process of claim 1, wherein the authorizing comprises at least one of: permitting continued execution of the executable program, and permitting the executable program to one of access and utilize a secure resource.

6. An apparatus comprising a non-transitory memory medium configured to store a program executable by one or more processors to:
calculate using a secure component a cryptographic hash function (CHF) digest of at least a portion of the program;
access using the secure component a previously-calculated CHF digest of said at least the portion of the program contained in a white-box data structure of the program;
compare using the secure component the CHF digest and the previously-calculated CHF digest; and
if the CHF digest and the previously-calculated CHF digest compare as equal, authorize an operation of the executable program.

7. The apparatus of claim 6, wherein the program is executable by one or more processors to calculate the CHF digest in response to the program being launched.

8. The apparatus of claim 6, wherein the program is executable by one or more processors to calculate the CHF digest of the entirety of the program.

9. The apparatus of claim 8, wherein the program is executable by one or more processors to access the previously-calculated CHF digest using a key contained in the secure component.

10. The apparatus of claim 9, wherein the program is executable by one or more processors to authorize comprises at least one of: the program being executable by one or more processors to permit continued execution of the executable program, and the program being executable by one or more processors to permit the executable program to one of access and utilize a secure resource.

11. A process for creating an executable program package capable of certificateless authentication (CLA package), the process comprising:
calculating a cryptographic hash function (CHF) digest at least a portion of the CLA package;
creating a white-box data structure including the CHF digest cryptographically associated with the at least the portion of the CLA package via a white-box cryptography technique; and
providing the CLA package including the CHF digest cryptographically associated with the at least the portion of the CLA package.

12. The process of claim 11, wherein said at least the portion of the CLA package includes the entirety of the CLA package.

13. The process of claim 11, wherein the calculating is performed on a secure development platform and the creating the white-box data structure is performed on a white-box cryptography platform in operative communication with the secure development platform.

14. A system for creating an executable program package capable of certificateless authentication (CLA package), the system comprising:
a cryptographic hash function (CHF) calculator configured to calculate a CHF digest of at least a portion of the CLA package;
a white-box component (WBC) generator configured to create a white-box data structure including the CHF digest cryptographically associated with the at least the portion of CLA package using a white-box cryptography technique; and
a CLA package generator configured to provide the CLA package including the CHF digest cryptographically associated with the at least the portion of the CLA package.

15. The system of claim 14, wherein said at least the portion of the CLA package includes the entirety of the CLA package.

16. The system of claim 14, wherein the cryptographic hash function (CHF) calculator is provided as a component of the CLA package generator.

17. The system of claim 14, wherein the CLA package generator is provided on a secure development platform and the WBC generator is provided on a white-box cryptography platform in operative communication with the secure development platform.
